(19) United States
(12) Patent Application Publication
(10) Pub. No.: US 2024/0338744 A1
(43) Pub. Date: Oct. 10, 2024

(54) COMPUTERIZED SYSTEMS AND METHODS FOR LOCATION-BASED CONTENT FILTERING AND DELIVERY

(71) Applicant: YAHOO ASSETS LLC, New York, NY (US)

(72) Inventors: Xue WU, San Jose, CA (US); Kostas TSIOUTSIOULIKLIS, Saratoga, CA (US); Paloma de JUAN, New York, NY (US); Martin ECKERT, Seattle, WA (US)

(21) Appl. No.: 18/297,176

(22) Filed: Apr. 7, 2023

(51) Int. Cl. G06Q 30/0601; G06F 16/2457

(52) U.S. Cl. CPC G06Q 30/0631; G06F 16/24575; G06F 16/24578

(57) ABSTRACT

The disclosed systems and methods provide novel mechanisms for a location-based and content-relevant recommendation framework. The disclosed framework involves a hierarchical artificial intelligence/machine learning (AI/ML) based solutions that maximizes content quality and user engagement. The framework can identify local news content and accurately match the local content to users based on a user-based location proximity and relevancy. Accordingly, such content can then be provided to each user, which can be based on each user's preference settings for receiving recommended content.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to content recommendations, and more particularly to, computerized mechanisms for providing users with local-based content related to their geographical location and personalized interests.

### BACKGROUND

Recent trends in media outlets have shown that people from the United States are highly interested in local news articles (e.g., articles pertaining to their neighborhoods). Coupled with the recent COVID-19 pandemic, general user interest in local newspapers has increased by 9% from 2019 (e.g., a total of 44% since the fourth quarter of 2014). Local news has become one of the key content types for many media sites.

### SUMMARY

Accordingly, the disclosed systems and methods provide a recommendation framework that produces an optimal set of local news articles for users. As discussed herein, the disclosed framework involves a hierarchical artificial intelligence/machine learning (AI/ML) based solution that maximizes content quality and user engagement. For example, by providing users articles related to their current location (e.g., their local town, for example), that also contain content related to their interests, the disclosed framework can evidence an increase in user engagement (e.g., an increase of 45% over other types of national news), as well as other key performance metrics (KPMs)).

According to some embodiments, the disclosed hierarchical recommendation framework can identify local news content and accurately match the local content to users based on a user-based location proximity and relevancy. Accordingly, in some embodiments, such content can then be served to each user, which can be based on each user's preference settings for receiving recommended content.

In accordance with one or more embodiments, the present disclosure provides computerized methods for a framework that provides users with local-based content related to their geographical location and personalized interests. In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device cause at least one processor to perform a method for a novel and improved framework that provides users with local-based content related to their geographical location and personalized interests.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts a schematic diagram illustrating an example of client device in accordance with some embodiments of the present disclosure;

FIG. 3 is a block diagram illustrating components of an exemplary system in accordance with some embodiments of the present disclosure; and

FIG. 4 is a block diagram illustrating an exemplary workflow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

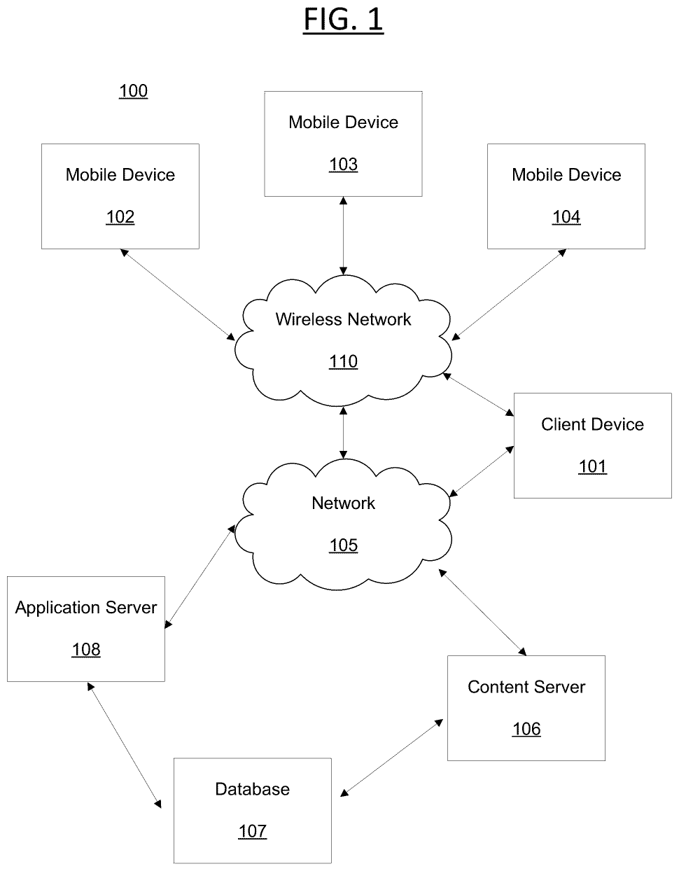

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)-network 105, wireless network 110, mobile devices (client devices) 102-104 and client device 101. FIG. 1 additionally includes a variety of servers, such as content server 106 and application (or “App”) server 108.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing articles, memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. Content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like.

In some embodiments, content server 106 can be, or may be coupled or connected to, a third party server that stores online advertisements for presentation to users. In some embodiments, various monetization techniques or models may be used in connection with sponsored advertising, including advertising associated with user data, as discussed below, where ads can be modified and/or added to content based on the personalization of received content using the locally accessible user profile.

In some embodiments, users are able to access services provided by servers 106 and/or 108. This may include in a non-limiting example, search servers, authentication servers, email servers, social networking services servers, SMS servers, IM servers, MMS servers, exchange servers, photo-sharing services servers, ad servers and travel services servers, via the network 105 using their various devices 101-104.

In some embodiments, applications, such as, but not limited to, news applications, mail applications, instant messaging applications, blog, photo or social networking applications, search applications, and the like, can be hosted by the application server 108, or content server 106 and the like.

Thus, the application server 108 and/or content server 106, for example, can store various types of applications and application related information including application data and other various types of data related to the content and services in an associated database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106 and/or 108.

Moreover, although FIG. 1 illustrates servers 106 and 108 as single computing devices, respectively, the disclosure is not so limited. For example, one or more functions of servers 106 and/or 108 may be distributed across one or more distinct computing devices. Moreover, in one embodiment, servers 106 and/or 108 may be integrated into a single computing device, without departing from the scope of the present disclosure.

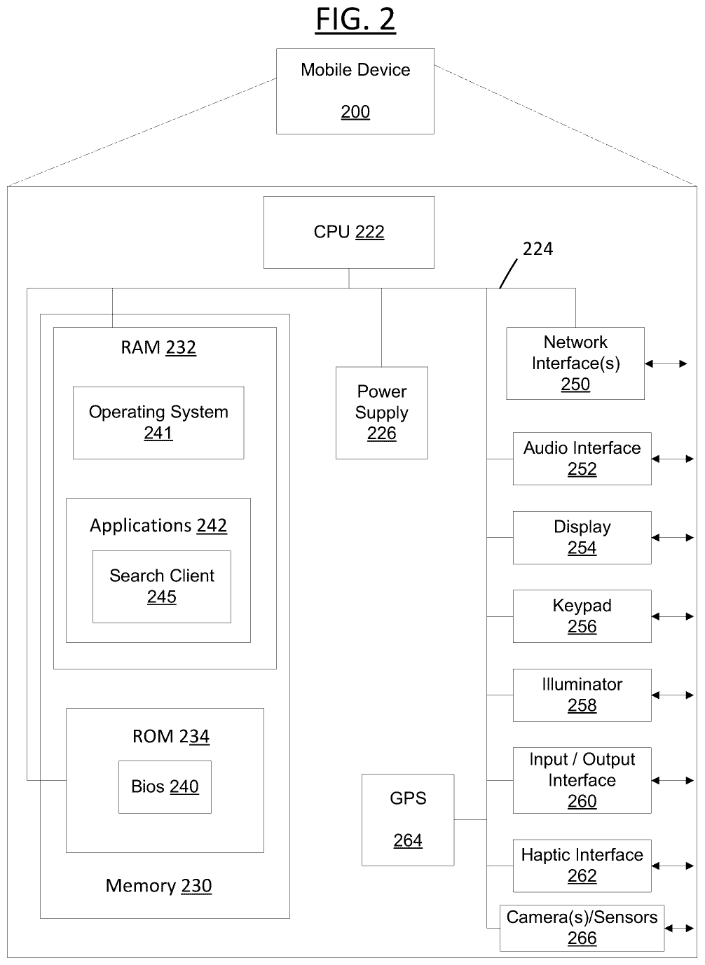

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices 101-104 as discussed above in relation to at least FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to client device 200.

Client device 200 may optionally communicate with a base station (not shown), or directly with another computing device. Network interface 250 is sometimes known as a transceiver, transceiving device, or network interface card (NIC).

Audio interface 252 can be arranged to produce and receive audio signals such as, for example, the sound of a human voice. Display 254 can, but is not limited to, a include a touch sensitive screen arranged to receive input from an object such as a stylus or a digit from a human hand. Keypad 256 can comprise any input device arranged to receive input from a user. Illuminator 258 may provide a status indication and/or provide light.

Client device 200 also comprises input/output interface 260 for communicating with external devices. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of client device 200 on the surface of the Earth. In some embodiments however, client device 200 may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 stores a basic input/output system (“BIOS”) 240 for controlling low-level operation of client device 200. The mass memory also stores an operating system 241 for controlling the operation of client device 200

Memory 230 further includes one or more data stores, which can be utilized by client device 200 to store, among other things, applications 242 and/or other information or data. For example, data stores may be employed to store information that describes various capabilities of client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 200.

Applications 242 may include computer executable instructions which, when executed by client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

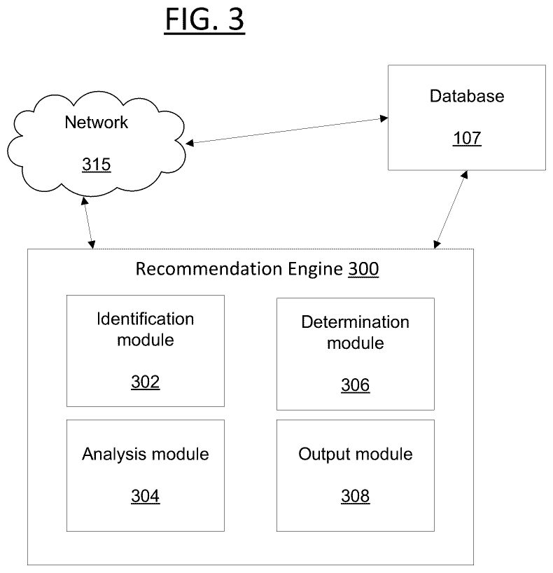

FIG. 3 is a block diagram illustrating the components for performing the systems and methods discussed herein. FIG. 3 includes recommendation engine 300, network 315 and database 107. The recommendation engine 300 can be a special purpose machine or processor and could be hosted by a network server (e.g., cloud web services server(s)), messaging server, application server, content server, social networking server, web server, search server, content provider, third party server, user's computing device, and the like, or any combination thereof.

According to some embodiments, recommendation engine 300 can be embodied as a stand-alone application that executes on a networking server. In some embodiments, the recommendation engine 300 can function as an application installed on a user's device, and in some embodiments, such application can be a web-based application accessed by the user device over a network. In some embodiments, the recommendation engine 300 can be configured and/or installed as an augmenting script, program or application (e.g., a plug-in or extension) to another application or portal data structure.

The database 107 can be any type of database or memory, and can be associated with a content server on a network (e.g., content server, a search server or application server) or a user's device (e.g., device 101-104 or device 200 from FIGS. 1-2). Database 107 includes a dataset of data and metadata associated with local and/or network information related to users, services, applications, content, content and/or service providers, third party websites and the like.

In some embodiments, such information can be stored and indexed in the database 107 independently and/or as a linked or associated dataset. In some embodiments, database 107 can be any type of known or to be known data storage on a network, including, but not limited to, a look-up table (LUT), a node on a network, an edge device, peer on a network, file storage, block storage, object storage, distributed ledger (e.g., blockchain), object oriented database, distributed database, centralized database, and the like. Database 107 can receive storage instructions/requests from, for example, engine 300, which may be in any type of known or to be known format, such as, for example, standard query language (SQL).

As discussed herein, it should be understood that the data and metadata in the database 107 can be any type of information and type, whether known or to be known, without departing from the scope of the present disclosure. By way of a non-limiting example, as discussed in more detail below, the data can correspond to, but is not limited to, any type of content (e.g., text, web pages, images, video, and the like, for example), as well as, but not limited to, information associated with a user profile, user interests, user behavioral information, user attributes, user preferences, user demographic information, user location information (e.g., geographic information), user biographic information, and the like, or some combination thereof.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the recommendation engine 300, and the database 107 of stored resources. Indeed, as illustrated in FIG. 3, the recommendation engine 300 and database 107 can be directly connected by any known or to be known method of connecting and/or enabling communication between such devices and resources.

The principal processor, server, or combination of devices that comprise hardware programmed in accordance with the special purpose functions herein is referred to for convenience as recommendation engine 300, and includes identification module 302, analysis module 304, determination module 306 and output module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

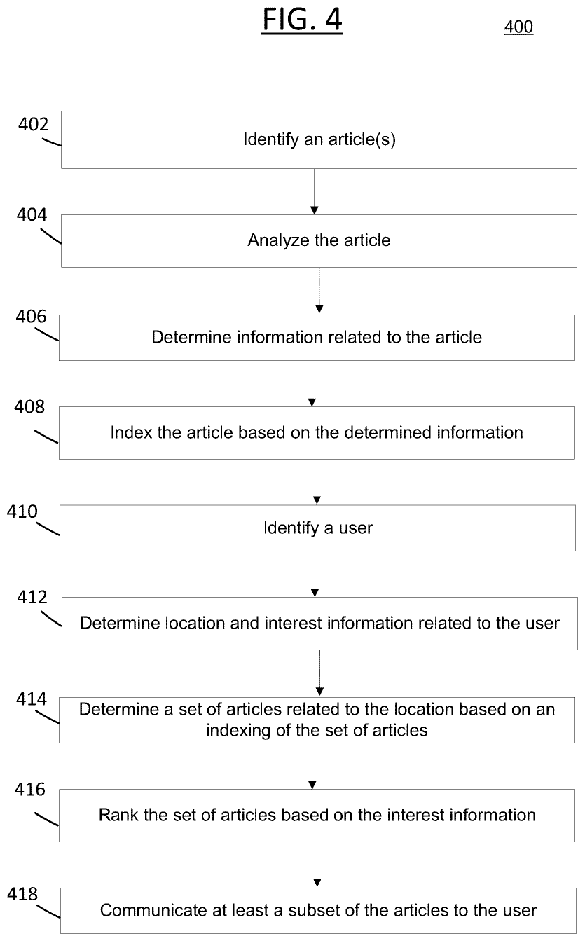

Turning to FIG. 4, depicted is Process 400 which details non-limiting example embodiments for performing the disclosed local content recommendation. As discussed herein, local content, specifically, for example, local news, is a special type of content (e.g., article) that pertains to users in a specific area. For example, in contrast to national or international news, local news caters to the news of a regional and local community, and focuses on localized issues and events. For example, local news can have features related to, but not limited to, regional politics, weather, business, and human interest stories, and the like.

Accordingly, while the discussion herein will focus on local news content, it should not be construed as limiting, as it should be understood that the content can correspond to and/or be of any type of locally-based content, including, but not limited to, images, videos, multi-media, text, audio, and the like, or some combination thereof.

According to some embodiments, Process 400 provides a pipeline for processing newly ingested articles in real-time (or near real-time or substantially real-time). As provided below, news articles can be classified into different categories, including local news, and can be tagged with location information (e.g. which can be based on the article's title, body, metadata, source, and the like). At serving time, local news articles are ranked and matched to users based on the users' locations and their corresponding interests.

According to some embodiments, Steps 402 and 410 can be performed by identification module 302 of recommendation engine 300; Step 404 can be performed by analysis module 304; Steps 406 and 412-416 can be performed by determination module 306; and Steps 408 and 418 can be performed by output module 308.

According to some embodiments, Process 400 begins with Step 402 where engine 300 identifies an article (e.g., a content item, as discussed herein). It should be understood that while the discussion herein will focus on providing a local news article to a user, the disclosed framework is applicable to a plurality of articles for a plurality of users. Thus, in Step 402, the identification of an article can correspond to a set or plurality of articles.

According to some embodiments, the article identified in Step 402 can be based on and/or resultant from the article being uploaded, posted, shared or otherwise being made available online. For example, if a local newspaper posts an article to their website, Step 402 can involve engine 300 identifying such article.

In Step 404, engine 300 can analyze the identified article. As discussed herein, the analysis of article can involve determining information about the article including, but not be limited to, features, characteristics, attributes, keywords, context (e.g., topic and/or geographic location of the article's content, for example), a source, type of article, and the like of the article.

According to some embodiments, the computational analysis performed in Step 404 can involve parsing the article and extracting data/metadata which can correspond to specific types of determined information, as discussed above. In some embodiments, the analysis can be performed via engine 300 executing and/or implementing any type of known or to be known computational analysis technique, algorithm, mechanism or technology, which can include, but is not limited to, a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 300 may be configured to utilize one or more AI/ML techniques including, but not limited to, computer vision, feature vector analysis, decision trees, boosting, support-vector machines, neural networks, nearest neighbor algorithms, Naive Bayes, bagging, random forests, logistic regression, and the like. In some embodiments, a neural network technique may be one of, without limitation, feedforward neural network, radial basis function network, recurrent neural network, convolutional network (e.g., U-net) or other suitable network.

Accordingly, in Step 406, engine 300 can determine the information related to the article based on the analysis in Step 404. For example, Step 406 can involve creating a data structure that indicates information indicating a context of the article and the location related to the article/context. For example, the article can describe an incoming Nor-ester to impact New England over a 3 day span.

Thus, in some embodiments, Step 406 can involve classifying the article based on the determined information. For example, based on the analysis from Step 404, text features of the article can be extracted, whereby engine 300 can apply a multinomial logistic regression model to classify the article based on such features. For example, such classification can correspond to topics/categories including, but not limited to, business, sports, entertainment, science, lifestyle, weather, politics, and the like.

According to some embodiments, for example, ƒ=[ƒ1, . . . , ƒj, . . . , ƒd]^{T} can be a vector of term frequency-inverse document frequency (TF-IDF) feature values representing the article. The article can correspond to a category k∈1, . . . , K by a K-dimensional 0/1 valued vector y=(y1, . . . , yK)T, where yk=1 and all other coordinates are 0.

According to some embodiments, multinomial logistic regression provides a conditional probability model of the form:

$$p ( {y}_{k} = 1 \vert f , A ) = \frac{exp ( {a}_{{k}^{′}}^{T} f )}{{\sum }_{{k}^{′}} exp ( {a}_{{k}^{′}}^{T} f )} , \qquad Eq . 1$$

where A=[a1, . . . , ak] is the weight matrix with column of A corresponding to one of the category classes. In some embodiments, engine 300 can classify an article based on a highest conditional probability estimate:

$$\hat{y} ( f ) = {arg max}_{k} p ( {y}_{k} = 1 \vert f ) . \qquad Eq . 2$$

According to some embodiments, such classification can be performed in both online and offline environments.

In some embodiments, in addition to features, information related to named entities and/or locations can be extracted from the article. For example, for each location named entity, the granularity of the location, the position of the entity in the article, frequency of the entity appearance, the appearance of the ancestor of the location, and distance of the entity to the centroid of the location entities can be combined linearly to calculate a location aboutness score.

For example, g=[g1, . . . , gk], which is a vector of geolocation features, and w=[w1, . . . , wk], which is a corresponding weight vector. Engine 300 can calculate an aboutness score A of each location entity l as follows:

$${A}_{l} = {\sum }_{k} {w}_{k} {g}_{k} . \qquad Eq . 3$$

According to some embodiments, a location aboutness score can be used to measure the relevancy of the location to the events mentioned in the articles. Accordingly, as part of Step 406, engine 300 can tag all local news articles with i) features, ii) entity/location information and iii) a location aboutness score.

In Step 408, engine 300 can cause the article and the determined information (e.g., the data structure of the determined information and/or tags from Step 406) to be indexed. In some embodiments, such indexing can correspond to storing the article in a database (e.g., database 107, as discussed above).

In Step 410, engine 300 can identify a user. In some embodiments, the identification of the user can be based on, but not limited to, a user request, a user action, a user being detected at a specific location, a user interacting with another user, a user visiting a network resource (e.g., signing into a web portal, visiting a website, and the like), user settings/preferences, a subscription, and the like, or some combination thereof. In some embodiments, the identification of the user can be automatically determined based on the above mentioned mechanisms for identifying the user (e.g., detect the user has logged into a web portal, therefore, identify the user for purposes of providing them local news, for example).

Accordingly, in some embodiments, Step 410 can involve identifying information related to the user, which can include, but is not limited to, a user identifier (ID), type of device the user is using, IP address, location (e.g., zip code, for example), interests and/or behavioral data, and/or any other type of user profile data, as discussed above, and/or some combination thereof.

In Step 412, engine 300 can determine location and interest information related to the user. In some embodiments, such information can be derived, extracted, retrieved or otherwise identified from the information from Step 410, as discussed above. In some embodiments, engine 300 can retrieve such data from a user profile of the user, and/or ping a device of the user to detect their current location and/or residence location (e.g., a “home” location).

In Step 414, engine 300 can determine a set of articles related to the user's location from the indexed set of articles. In some embodiments, a query can be compiled that includes information related to the user's location; and in some embodiments, the query can further include user interest information. Accordingly, the query can be used to identify a set of articles that correspond to the user's location (e.g., contextually discuss topics related to the user's location, as discussed above).

In some embodiments, the query in Step 414 can further be based on the interest information. Thus, articles that i) correspond to the location and ii) correspond to the user's interests can be compiled via the query.

In some embodiments, as in Step 414, an article location can be represented by a location vector of all related locations. For each user, a user location vector can be generated, and at least be based on the location (e.g., current or home location of a user. Thus, relevant articles can be identified based on a dot product between user location vector and article location vector.

In some embodiments, the articles identified in Step 414 can further be based on a time period/criteria, for example, 2 days. Thus, only the most recent and/or topical articles can be identified via the search. In some embodiments, the time criteria can further be utilized to archive the indexed database so as to ensure only the most temporally relevant articles are identified. Moreover, in some embodiments, the time period or similar type of time period can be utilized to identify the article upon its publishing, as in Step 402.

In Step 416, engine 300 can analyze the compiled listing of articles (from Step 414) and determine a ranking or order of the articles. The ranking can be based on how interesting the articles are to the user. For example, if the interest information or behavior of the user indicates that the user is most interested in weather and least interested in politics, then the article ranking would order the weather articles above the politics articles. Accordingly, in some embodiments, the ranking can be performed via an AI/ML model, as discussed above, which can enable a similarity analysis to a set of user data indicating their interests.

In some embodiments, engine 300 can utilize a point-wise ranking with gradient boosted decision trees algorithms, which take the features from the user and article, and provide a probabilistic output of the likelihood of a user clicking on certain content. Accordingly, in some embodiments, the point-wise approach can involve a ranking function ƒ(x) that predicts a real value or ordinal score of a documents d (e.g., article) using the loss function L(ƒ,dj,yj).

According to some embodiments, engine 300 can utilize any type of known or to be known AI/ML model in a similar manner as discussed above at least in relation to Step 404. For example, engine 300 can utilize an AI/ML model including, but not limited to, feature vector analysis, decision trees, boosting, support-vector machines, neural networks, nearest neighbor algorithms, Naive Bayes, bagging, random forests, logistic regression, and the like.

And, in Step 418, engine 300 can provide or communicate at least a subset of the articles to the user. In some embodiments, only a top ranked article can be provided to the user. In some embodiments, the articles can be communicated in a manner that enables the user to view each article by interacting with a dedicated link for each article. Accordingly, any type of known or to be known mechanisms for communicating the articles can be enabled via engine 300 in Step 418.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternative embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a user, the user being associated with a location and having a set of predetermined interests;
querying, by the device, an indexed database of a plurality of news articles, each news article having corresponding tags indicating a location and context;
identifying, by the device, a set of news articles based on the query, the set of articles comprising content corresponding to the user location, the context of the set of articles corresponding to the predetermined interests of the user; and
communicating, by the device, the set of news articles to a device of the user.

2. The method of claim 1, further comprising:
analyzing the set of articles; and
determining a ranking of the set of articles, wherein the ranking is based on an analysis of the context of the set of articles respective to the predetermined interests of the user, wherein communication of the set of news articles is based on the determined ranking.

3. The method of claim 1, further comprising:
identifying, over a network, the plurality of news articles;
analyzing the plurality of news articles;
determining, based on the analysis, information related to each of the articles in the plurality; and
categorizing each of the articles in the plurality based on the determined information.

4. The method of claim 3, wherein the categorization provides an indication of a type topic covered in each news article, wherein the tags in the indexed database are based on the categorization.

5. The method of claim 3, wherein the identification of the plurality of news articles corresponds to a time period related to publishing of the news article on the network.

6. The method of claim 1, wherein the query comprises information related to the user location and a time period.

7. The method of claim 1, wherein the location of the user is a current location of the user.

8. The method of claim 1, wherein the location of the user corresponds to a residence of the user.

9. The method of claim 1, further comprising:
detecting an action related to the user, wherein the identification of the user is based on detection of the action.

10. The method of claim 9, wherein the action corresponds to a user request.

11. A non-transitory computer-readable storage medium tangibly encoded with computer-executable instructions, that when executed by the device, performs a method comprising:
identifying, by a device, a user, the user being associated with a location and having a set of predetermined interests;
querying, by the device, an indexed database of a plurality of news articles, each news article having corresponding tags indicating a location and context;
identifying, by the device, a set of news articles based on the query, the set of articles comprising content corresponding to the user location, the context of the set of articles corresponding to the predetermined interests of the user; and
communicating, by the device, the set of news articles to a device of the user.

12. The non-transitory computer-readable storage medium of claim 11, further comprising:
analyzing the set of articles; and
determining a ranking of the set of articles, wherein the ranking is based on an analysis of the context of the set of articles respective to the predetermined interests of the user, wherein communication of the set of news articles is based on the determined ranking.

13. The non-transitory computer-readable storage medium of claim 11, further comprising:
identifying, over a network, the plurality of news articles;
analyzing the plurality of news articles;
determining, based on the analysis, information related to each of the articles in the plurality; and
categorizing each of the articles in the plurality based on the determined information.

14. The non-transitory computer-readable storage medium of claim 13, wherein the categorization provides an indication of a type topic covered in each news article, wherein the tags in the indexed database are based on the categorization.

15. The non-transitory computer-readable storage medium of claim 11, wherein the query comprises information related to the user location and a time period.

16. A device comprising:
a processor configured to:
identify a user, the user being associated with a location and having a set of predetermined interests;
query an indexed database of a plurality of news articles, each news article having corresponding tags indicating a location and context;
identify a set of news articles based on the query, the set of articles comprising content corresponding to the user location, the context of the set of articles corresponding to the predetermined interests of the user; and
communicate the set of news articles to a device of the user.

17. The device of claim 16, wherein the processor is further configured to:
analyze the set of articles; and
determine a ranking of the set of articles, wherein the ranking is based on an analysis of the context of the set of articles respective to the predetermined interests of the user, wherein communication of the set of news articles is based on the determined ranking.

18. The device of claim 16, wherein the processor is further configured to:
identify, over a network, the plurality of news articles;
analyze the plurality of news articles;
determine, based on the analysis, information related to each of the articles in the plurality; and
categorize each of the articles in the plurality based on the determined information.

19. The device of claim 18, wherein the categorization provides an indication of a type topic covered in each news article, wherein the tags in the indexed database are based on the categorization.

20. The device of claim 16, wherein the query comprises information related to the user location and a time period.
